(19) United States
(12) Patent Application Publication
(10) Pub. No.: US 2019/0313480 A1
(43) Pub. Date: Oct. 10, 2019

(54) METHOD AND APPARATUS FOR FORMING A NETWORK

(71) Applicant: MOTOROLA SOLUTIONS, INC, CHICAGO, IL (US)

(72) Inventors: BING QIN LIM, JELUTONG (MY); CHONG HIN CHEE, GELUGOR (MY); YEE BING HONG, BAYAN LEPAS (MY); STEVEN JOHN KERR, BAYAN LEPAS (MY); SWEE HAK LAW, BUKIT MERTAJAM (MY); RM MUTHAIAH RAMANATHAN, BAYAN LEPAS (MY); LEE SUN OOI, KULIM (MY)

(21) Appl. No.: 16/314,876

(22) PCT Filed: Aug. 3, 2016
(86) PCT No.: PCT/MY2016/000045

§ 371 Date: Jan. 3, 2019

(51) Int. Cl. H04W 84/18; G06Q 10/06; H04W 40/24; H04L 12/24; H02J 7/00

(52) U.S. Cl. CPC H04W 84/18; G06Q 10/063112; H02J 7/0027; H04L 41/0631; H04W 40/24

(57) ABSTRACT

A method and apparatus for quickly forming a PAN is describe herein. During operation, a person (e.g., a public-safety officer) will be assigned a task or mission that is identified by an identifier (e.g., an incident identifier, or an incident type). A subset of available devices will be paired/associated to form a PAN based on the identified task or mission. In an alternate embodiment of the present invention the subset of available devices may be paired with an existing PAN based on the identified task or mission.

### FIELD OF THE INVENTION

The present invention generally relates to forming a network, and more particularly to a method and apparatus for forming a network based upon an assignment type.

### BACKGROUND OF THE INVENTION

Next-generation public safety officers will be equipped with devices that determine various physical and environmental conditions surrounding the public-safety officer. These conditions are generally reported back to a dispatch operator at a dispatch center so an appropriate action may be taken. For example, future police officers may have a sensor that determines when a gun is drawn. Upon detecting that an officer has drawn their gun, a notification may be sent back to the dispatch operator so that, for example, other officers in the area may be notified of the situation.

It is envisioned that the public-safety officer of the future will have an array of shelved devices available to the officer at the beginning of a shift or at the assignment of a particular task. The officer will select the devices off the shelf, and form a personal area network (PAN) with the devices that will accompany the officer on their shift or task. For example, upon the assignment of a particular task, the officer may pull a gun-draw sensor, a body-worn camera, a wireless microphone, a smart watch, a police radio, a man-down sensor, . . . , etc. All devices pulled by the officer will be configured to form a PAN by associating (pairing) with each other and communicating wirelessly among the devices.

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

Thus, pairing and unpairing devices to form or tear down a PAN typically involves some level of user interaction. This user interaction is the basis for confirming the identity of devices. Once pairing successfully completes, a bond will have been formed between the two devices, enabling those two devices to connect to each other in the future without again requiring the pairing process. When desired, the bonding relationship can later be removed by the user.

Because devices are pulled randomly at the beginning of a shift/task, an officer may pull a different array of devices every time they form a PAN. This requires that old bonds be cleared from every device at the end of a shift/task, and new be formed every time the officer pulls devices at the beginning of their shift/task.

A problem with the above-described scenario is that forming a PAN at the beginning of a shift/task from the pulled devices, as well as tearing down the PAN at the end of the shift/task from the pulled devices can take a considerable amount time for the officer. For example, a public-safety officer will need to access each device and “associate/pair” the device to the PAN at the beginning of their shift/task. In a similar manner, the public-safety officer will need to access each device and “disassociate/unpair” the device from the PAN at the end of their shift/task. This will take a considerable amount of time and effort. Considering this fact, there is a need for a method and apparatus for quickly forming a PAN that requires little user interaction to do so.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for the present invention.

FIG. 2 depicts an example communication system.

FIG. 3 depicts a more-detailed view of the personal-area network of FIG. 1.

FIG. 4 is a block diagram of a controller of FIG. 1.

FIG. 5 illustrates the charging ports of FIG. 1.

FIG. 6 is a flow chart showing operation of the controller of FIG. 4.

FIG. 7 is a flow chart showing operation of the controller of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for quickly forming a PAN is describe herein. During operation, a person (e.g., a public-safety officer) will be assigned a task or mission that is identified by an identifier (e.g., an incident identifier or an incident type). A subset of available devices will be paired/associated to form a PAN based on the identified task or mission. In an alternate embodiment of the present invention the subset of available devices may be paired with an existing PAN based on the identified task or mission. In a further alternate embodiment of present invention, the subset of existing PAN devices may be unpaired from an existing PAN based on the identified task or mission.

Since devices uniquely needed for a particular incident/task are automatically associated or unassociated with each other to form a PAN, the time consumed during the formation of a PAN at the beginning of an assigned task or shift is greatly reduced.

In a further embodiment of the present invention, the subset of available devices forming the PAN will be identified by illuminating a light on, or in the proximity to each device within the subset of available devices.

In yet a further embodiment of the present invention, a computer-aided dispatch (CAD) incident identifier is utilized to determine a current task assigned to an officer. An incident identification (sometimes referred to as an incident scene identifier, or a CAD incident identifier) is generated for incidents where an officer is dispatched. This ID could be something as simple as a number, or something as complicated as an identification that is a function of populated fields, one of which may comprise an incident type.

It should be noted that the terms associate, associating, pair, pairing, form, and forming can be used interchangeably, and simply mean that a device is added to an existing PAN, or a PAN is created with the device as a member. The PAN described above that is formed between devices preferably comprises a wireless PAN that comprises a low-powered PAN carried over a short-distance wireless network technology such as PANs formed using the following standards: INSTEON, IrDA, Wireless USB, Bluetooth, Z-Wave, ZigBee, and Body Area Network. The reach of a wireless PAN varies from a few centimeters to a few meters. Associating/pairing and disassociating/unpairing a device from the PAN is well known in the art, and takes place as instructed by any of the above standards.

It should also be noted that the present invention forms a PAN with at least some devices that are not in service at the time of the incident. These devices are not associated with any network, talkgroup, . . . , etc. Once placed into service, the devices form a PAN that is generally under the control of one user, and is very local in nature (e.g., within 10 feet). The PAN is formed by automatically associating and pairing those devices needed for a particular task/incident. For example, when an officer accepts a task/mission, a device currently associated with the officer (e.g., their police radio) may automatically identify the devices that are required for the incident/mission based on the incident type.

The devices that are identified shall connect to the officer's PAN, or if no PAN currently exists, the identified devices will form a PAN with the police radio, for example.

As an example of the above, assume an officer is assigned a task to issue parking tickets, the devices necessary for the tasks may be identified as a radio, a hand-held tablet, a camera, and a portable printer. The necessary devices will be instructed to form a PAN, while the devices that are not required for the mission (e.g., a helmet) will not be part of the PAN. It should be noted that there may be multiple redundant devices of a particular type (e.g., multiple cameras) that are being charged and not currently part of a network. In the preferred embodiment, only one device from the multiple redundant devices will be paired with the PAN.

As one of ordinary skill in the art will recognize, during the formation of a Bluetooth PAN there is typically one master device (hub) and one or more slave devices. The number of slave devices is limited by the capability of the master device. All communication within a PAN is between the master and slave devices. There is no direct communication between the slave devices over a PAN, although these devices may have separate Bluetooth connections between them that does not use the PAN.

After a PAN is established, the slave devices are synchronized to the timing and frequencies specified by the master device (sometimes referred to as a hub). Note that in a PAN, each slave device uses a different physical channel. Thus, a PAN starts with two connected devices, and may grow to any number of connected devices (although in some systems eight is the maximum number of devices within a Bluetooth PAN). Bluetooth communication always designates one of the Bluetooth devices as a main controlling unit or master unit. Other devices that follow the master unit are slave units. This allows the Bluetooth system to be non-contention based (no collisions). This means that after a Bluetooth device has been added to the PAN, each device is assigned a specific time period to transmit and they do not collide or overlap with other units operating within the same PAN.

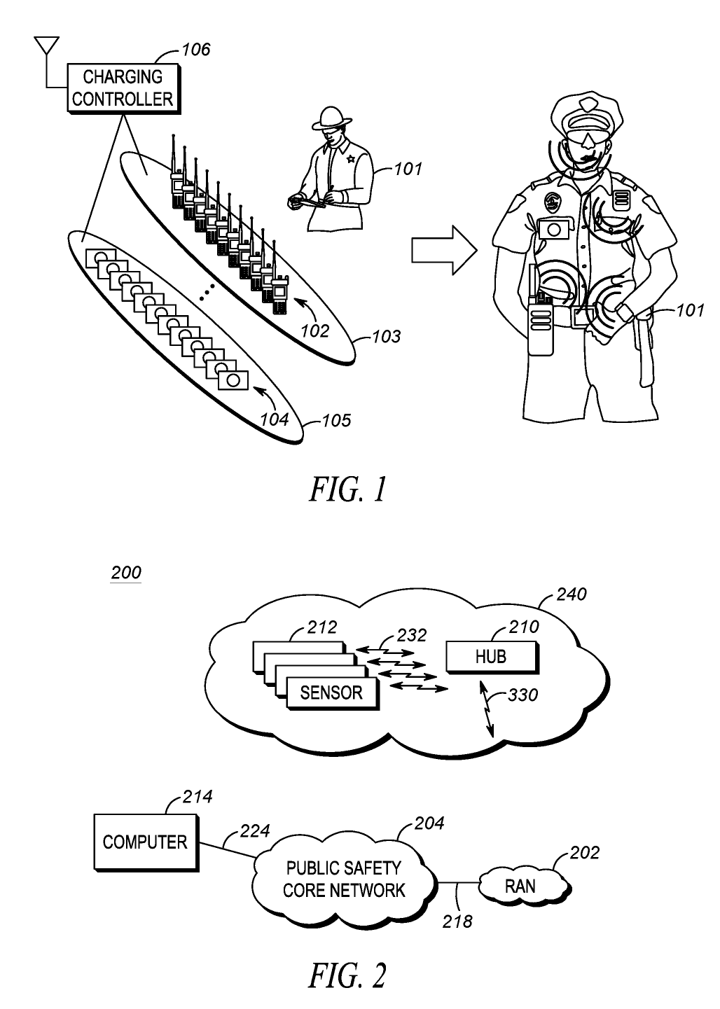

FIG. 1 depicts a general operating environment for the above-described technique for forming a PAN. As shown, public-safety officer 101 has an array of devices 102 and 104 to use during the officer's shift. For example, the officer may be assigned one radio 102 and one camera 104 for use during their shift or during a particular task. Other devices may be assigned as well. As shown, devices 102 and 104 may be located on a charging port 103/105. Ports 103 and 105 will preferably be equipped with a controller 106 to receive an incident ID, and instruct a subset of devices 104/104 to form a PAN.

When any device 102/104 is placed in/on ports 103/105, the devices will proceed into a charging state and a device ID will be detected by the charger. The device ID will uniquely identify the type of device. Controller 106 can receive the device ID thru any technique that convey an ID, for example, near-field communications (NFC) or via direct charging contact/ports. The device ID conveys information such as the device type, and current network association (if any).

As shown in FIG. 1, officer 101 will preferably wear the devices during a shift or incident by attaching the devices to worn clothing. These devices will form a PAN throughout the officer's shift or assigned task.

FIG. 2 depicts an example communication system 200 that incorporates PANs created as described above. System 200 includes one or more radio access networks (RANs) 202, a public-safety core network 204, hub (PAN master device) 210, local devices (slave devices) 212, a computer 214, and communication links 218, 224, and 232. In a preferred embodiment of the present invention, hub 210 and devices 212 form a PAN 240, with communication links 232 between devices 212 and hub 210 taking place utilizing a short-range communication system protocol such as a Bluetooth communication system protocol.

Each RAN 202 includes typical RAN elements such as base stations, base station controllers (BSCs), routers, switches, and the like, arranged, connected, and programmed to provide wireless service to user equipment (e.g., hub 210, and the like) in a manner known to those of skill in the relevant art.

The public-safety core network 204 may include one or more packet-switched networks and/or one or more circuit-switched networks, and in general provides one or more public-safety agencies with any necessary computing and communication needs, transmitting any necessary public-safety-related data and communications.

The hub 210 may be any suitable computing and communication devices configured to engage in wireless communication with the RANs 202 over the air interface as is known to those in the relevant art. Moreover, one or more hub 210 are further configured to engage in wired and/or wireless communication with one or more local device 212 via the communication link 232. Hub 210 will be configured to determine when to forward information via RANs 202 based on a combination of device 212 inputs.

Devices 212 and hub 210 may comprise any device capable of forming a PAN. For example, devices 212 may comprise a gun-draw sensor, a camera, a GPS receiver capable of determining a location of the user device, a clock, calendar, environmental sensors (e.g. a thermometer capable of determining an ambient temperature, humidity, presence of dispersed chemicals, radiation detector, etc.), an accelerometer, a barometer, speech recognition circuitry, a gunshot detector, . . . , etc.

Any one or more of the communication links 218, 224, could include one or more wireless-communication links and/or one or more wired-communication links.

Finally, computer 214 is part of a computer-aided-dispatch center, manned by an operator providing necessary dispatch operations. For example, computer 214 typically comprises a graphical user interface that provides the dispatch operator necessary information about public-safety officers. As discussed above, much of this information originates from devices 212 providing information to hub 210, which forwards the information to RAN 202 and ultimately to computer 214.

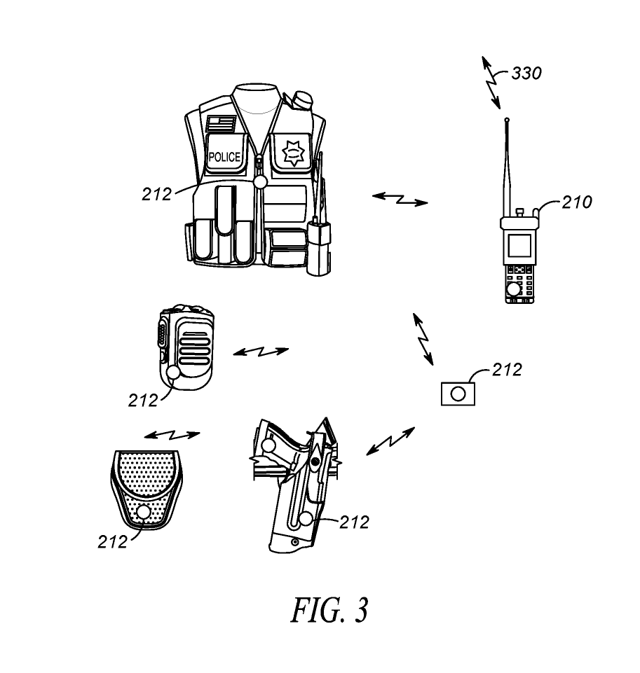

FIG. 3 depicts a more-detailed view of the personal-area network of FIG. 2. Personal-area network comprises a very local-area network that has a range of, for example 10 feet. As shown in FIG. 3, various devices 212 are shown attached to equipment utilized by a public-safety officer. In this particular example, a bio-sensor is located within a police vest, a voice detector is located within a police microphone, a handcuff deployment sensor is located with a handcuff pouch, a gun-draw sensor is located within a holster, and a camera 212 is provided. In FIG. 3, all sensors (except for camera 212) are represented by circles attached to an item to be monitored.

Devices 212 and hub 210 form a PAN 240. PAN 240 preferably comprises a Bluetooth PAN. Devices 212 and hub 210 are considered Bluetooth devices in that they operate using a Bluetooth, a short range wireless communications technology at the 2.4 GHz band, commercially available from the “Bluetooth special interest group”. Devices 212 and hub 210 are connected via Bluetooth technology in an ad hoc fashion forming a PAN. Hub 210 serves as a master device while devices 212 serve as slave devices. Devices 212 notify hub 210 of a sensed condition by sending a local status alert transmitted from the sensor as a Bluetooth message. Hub 210 in turn, may forward the local status alert over a wide-area network (e.g., RAN/Core Network) to computer 214. In alternate embodiments of the present invention, hub 210 may forward the local status alert to mobile and non-mobile peers (shift supervisor, peers in the field, etc), or to the public via social media.

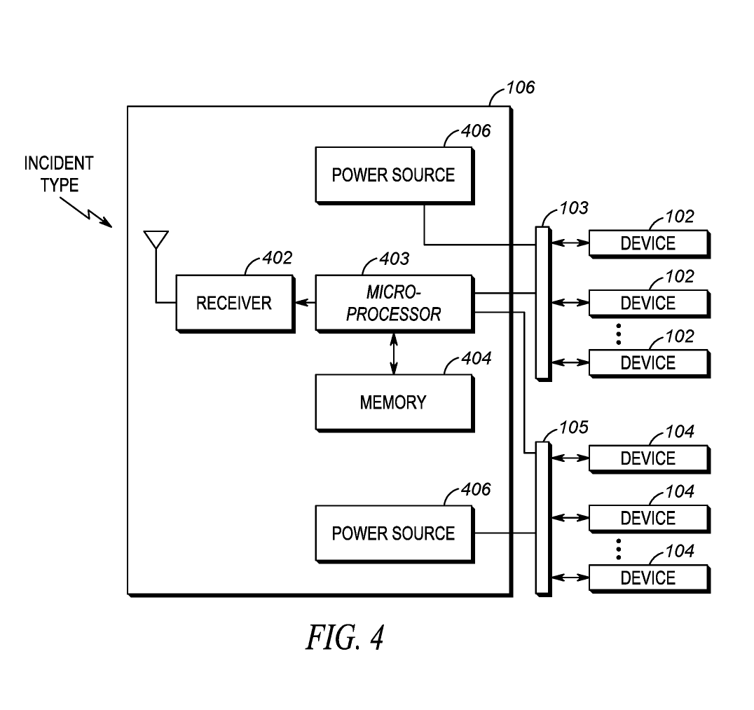

FIG. 4 is a block diagram of a controller 106 of FIG. 1. As shown, controller 106 may include receiver 402, power source 406, logic circuitry (microprocessor) 403, and memory 404. In other implementations, controller 106 may include more, fewer, or different components.

Receiver 402 may be well known long-range and/or short-range transceivers that utilize any number of network system protocols. For example, receiver 402 may be configured to utilize Bluetooth communication system protocol for a body-area network, a private 802.11 network, a next-generation cellular communications protocol operated by a cellular service provider, or any public-safety protocol such as an APCO 25 network or the FirstNet broadband network. Although only a single receiver is shown in FIG. 4, one of ordinary skill in the art will recognize that multiple receivers may exist in controller 106 to provide simultaneous communications using any number of communication system protocols. Receiver 402 thus comprises common circuitry known in the art for communication utilizing a well known communication protocol, and serve as means for receiving, for example, a CAD incident identifier from a dispatch center, or from another device (e.g., via a hub through, for example communication signal 330).

Power source 406 (which may exist external to controller 106) provides a way of charging devices 102 and 104. In a particular embodiment, power source 406 is coupled to devices 102 and 104 by direct contact with devices 102 and 104 at ports 103 and 105. Thus ports 103 and 105 serves as a physical connection between power source 406 and devices 102 and 104. In the situation where devices 102 and 104 are wireless, ports 103 and 105 comprises a receiver that is both used to charge and receive data, for example a device ID. Thus, controller 106 comprises a device capable of generating a charging voltage and receiving a unique device identification for those devices currently being charged.

It should be noted that power source 406 and devices 102 and 104 comprise standard elements that are well known in the art of charging and powering devices. For example, power source 406 can comprise standard circuitry that is capable of direct and/or wireless charging when brought into contact/vicinity of devices 102 and 104.

Memory 404 comprises standard random access memory and is used to store incident identifiers and devices needed for each incident. Memory 404 may also store device identification information for those devices currently assigned to a user along with any PAN information for those assigned devices.

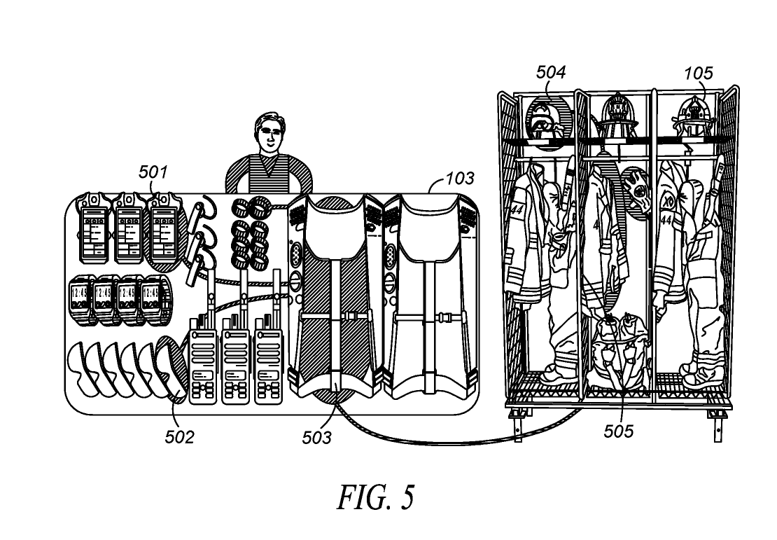

Logic circuitry 403 comprises a digital signal processor (DSP), general purpose microprocessor, a programmable logic device, or application specific integrated circuit (ASIC) and is configured to receive an incident type from receiver 402. Once an incident type is received, a PAN is formed with necessary devices in contact with controller 106 (e.g., those devices currently charging). More specifically, logic circuitry 403 instructs a subset of devices 102/103 to form, or join a PAN. As discussed above, the devices may be identified to a user by activating an indicator associated with the device. For example, all devices chosen may be instructed to activate their display screens in a similar manner, or all devices chosen may have an associated light activated. This is illustrated in FIG. 5.

The detection if the incident type is preferably accomplished by receiver 402 receiving an over-the-air communication from either another device (e.g., a master device already part of a PAN), or from dispatch center 214. Additionally, devices used to form a PAN are determined by logic circuitry 403 by accessing memory 404 and determining those devices needed based on an incident identification. In particular, memory 404 stores devices needed based on incident type. This information is used by logic circuitry 403 in determining a subset of devices 102/103 to automatically associate with a PAN.

With the above in mind, controller 106 is configured to:
receive an incident type;
determine devices needed for the incident type;
determine a plurality of devices available for forming a personal-area network (PAN); and
instruct a subset of the plurality of devices to form a PAN based on the devices needed for the incident type and also based on the devices available.

The PAN network is formed by logic circuitry 403 providing necessary information for pairing to (or forming) a PAN to those devices chosen. In a preferred embodiment, this is accomplished by providing the necessary information through ports 103 and 105. However, in an alternate embodiment of the present invention, a transmitter may be provided (not shown in FIG. 4) that will transmit the necessary information in a wireless manner to devices 102/104. In addition logic circuitry 403 may instruct devices 102/104 to listen for necessary PAN-forming messages transmitted by other devices. PAN formation takes place as described in, for example, the Bluetooth standard.

Thus, the device provided in FIG. 4 comprises a receiver receiving an incident type and logic circuitry determining devices needed for the incident type, determining a plurality of devices available for forming a personal-area network (PAN), and instructing a subset of the plurality of devices to form a PAN.

The device may further include a memory. The step of determining the devices needed for the incident type may comprise the step of accessing a memory to determine the devices needed.

The device may additionally comprise a charging port. The step of determining the plurality of devices available may comprise the step of determining a plurality of devices currently being charged at the charging port.

FIG. 5 illustrates operation of charging ports 103/105. In FIG. 5, charging port 103 is shown as a wireless charging table equipped with light sources located below devices that are being charged. Charging port 105 is shown as a wireless charging cabinet having a light source located behind devices being charged. During operation devices that are being used in the formation of a PAN are illuminated from below and behind. So for example, in FIG. 5, smart phone 501, glasses 502, harness 503, helmet 504, and coat 505 have been identified as devices necessary for a particular task/incident. As described above, these devices will be part of a PAN formed based on the particular task/incident. As shown in FIG. 5, these devices will have a light or other form of identification that will aide a user in obtaining the paired device.

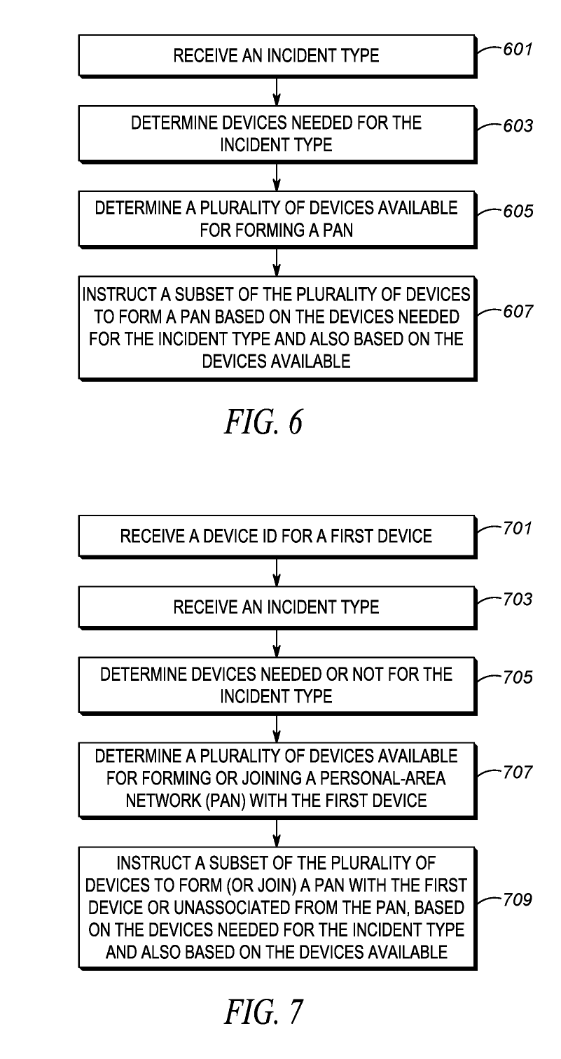

FIG. 6 is a flow chart showing operation of the controller of FIG. 4. More particularly, the flow chart of FIG. 6 shows those steps (not all are necessary) taken when controller 106 forms a PAN with a subset of devices based on a received incident identifier. The logic flow begins at step 601 where receiver 402 receiving an incident type. As discussed above, the incident type may comprise a CAD incident identifier received wirelessly via an over-the-air communication by a receiver from either another device or from a dispatch center. At step 603 logic circuitry 403 determines devices needed for the incident type. As discussed above, the determination may be made by logic circuitry 403 accessing memory 404 to associate a particular incident ID with necessary devices. Logic circuitry then determines a plurality of devices available for forming a PAN (step 605). As discussed the plurality of devices available may be determined as those devices currently coupled to ports 103 and 105 (i.e., currently charging). Finally, at step 607 logic circuitry 403 instructs a subset of the plurality of devices to form a PAN based on the devices needed for the incident type and also based on the devices available. This may be accomplished in a somewhat random fashion so that, for example, if it is determined that glasses are needed for the incident, a random pair of glasses may be chosen among those currently being charged (available). Other methods may be used to determine the device chosen for the PAN, for example, in a first-in-first-out manner, last-in-first-out manner, or any other manner.

FIG. 7 is a flow chart showing operation of the controller of FIG. 4. The flow chart of FIG. 7 describes those steps (not all of which are necessary) to associate a device with another device or with an existing PAN. In this particular embodiment, the logic flow begins at step 701 where receiver 402 receives a device ID for a first device. The first device is preferably a device that is part of an existing PAN, or somehow associated with a particular officer. For example, the first device may comprise a police radio (or any other device) serving as a hub, and assigned to the particular public-safety officer. The device ID is received via an over-the-air communication from either the dispatch center, or any other device (which may include the first device). Along with the first device ID, an incident type is received (step 703). At step 705 a determination is made by logic circuitry 403 of devices needed or not needed for the incident type, along with a plurality of devices available for forming or joining a personal-area network (PAN) with the first device (step 707). Finally, at step 709 logic circuitry 403 instructs a subset of the plurality of devices to form (or join) a PAN with the first device or unassociated from the PAN, based on the devices needed for the incident type and also based on the devices available.

The logic flow of FIG. 7 describes steps taken for a PAN to be created with a device carried by an officer. In this situation, an officer may already be assigned a particular device (e.g., a police radio), and at a later time, assigned to handle a particular incident. Since additional equipment may be needed as part of the officer's PAN, the additional equipment may be automatically instructed to join the officer's PAN when needed. Since additional equipment may be not needed as part of the officer's PAN, the additional equipment may be automatically instructed to unassociated from the officer' PAN.

As discussed above, the step of receiving the incident type may comprise the step of receiving the incident type at a receiver via an over-the-air communication. Additionally, the step of determining the devices needed for the incident type may comprise the step of accessing a memory to determine the devices needed, while the step of determining the plurality of devices available may comprise the step of determining a plurality of devices currently being charged.

In the foregoing specification, specific embodiments have been described. However, one of ordinary skill in the art appreciates that various modifications and changes can be made without departing from the scope of the invention as set forth in the claims below. For example, while the above technique was described with reference to forming/associating with a PAN, one of ordinary skill will recognize that a PAN, or association with any network may be achieved as described above. For example, association with a LAN may be performed as described above. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for forming a network, the method comprising the steps of:
receiving an incident type;
determining devices needed for the incident type;
determining a plurality of devices available for forming a personal-area network (PAN); and
instructing a subset of the plurality of devices to form a PAN based on the devices needed for the incident type and also based on the devices available.

2. The method of claim 1 wherein the step of receiving the incident type comprises the step of receiving the incident type at a receiver via an over-the-air communication.

3. The method of claim 1 wherein the step of determining the devices needed for the incident type comprises the step of accessing a memory to determine the devices needed.

4. The method of claim 1 wherein the step of determining the plurality of devices available comprises the step of determining a plurality of devices currently being charged.

5. A method comprising the steps of:
receiving a device identification (ID) for a first device;
receiving an incident type;
determining devices needed for the incident type;
determining a plurality of devices available for forming or joining a personal-area network (PAN) with the first device; and
instructing a subset of the plurality of devices to form or join a PAN with the first device based on the devices needed for the incident type and also based on the devices available.

6. The method of claim 5 wherein the step of receiving the incident type comprises the step of receiving the incident type at a receiver via an over-the-air communication.

7. The method of claim 5 wherein the step of determining the devices needed for the incident type comprises the step of accessing a memory to determine the devices needed.

8. The method of claim 5 wherein the step of determining the plurality of devices available comprises the step of determining a plurality of devices currently being charged.

9. The method of claim 5 further comprising the steps of:
instructing a subset of the plurality of devices from existing PAN to unassociated from the PAN.

10. An apparatus comprising:
a receiver receiving an incident type; and
logic circuitry determining devices needed for the incident type, determining a plurality of devices available for forming a personal-area network (PAN), and instructing a subset of the plurality of devices to form a PAN.

11. The apparatus of claim 10 wherein the receiver receives the incident type via an over-the-air communication.

12. The apparatus of claim 10 further comprising:
a memory; and
wherein the step of determining the devices needed for the incident type comprises the step of accessing the memory to determine the devices needed.

13. The apparatus of claim 10 further comprising:
a charging port;
and wherein the step of determining the plurality of devices available comprises the step of determining a plurality of devices currently being charged at the charging port.
